(19) United States
(12) Patent Application Publication
(10) Pub. No.: US 2021/0133887 A1
(43) Pub. Date: May 6, 2021

(54) EFFICIENTLY AGING AND MODIFYING POLICY RECORDS IN A TEST SYSTEM

(71) Applicant: STATE FARM MUTUAL AUTOMOBILE INSURANCE COMPANY, Bloomington, IL (US)

(72) Inventors: Mary Maureen Brandt, Bloomington, IL (US); Mark Mathias Boog, Grand Rapids, MI (US); Mark Emery Will, Downs, IL (US)

(21) Appl. No.: 15/896,245

(22) Filed: Feb. 14, 2018

Related U.S. Application Data
(63) Continuation of application No. 14/477,350, filed on Sep. 4, 2014, now abandoned.

(51) Int. Cl. G06Q 40/08

(52) U.S. Cl. CPC G06Q 40/08

(57) ABSTRACT

A computer system for aging insurance policies stored in a policy records database may be configured to receive, via a policy extraction unit, one or more user-entered policy criteria, use the user-entered policy criteria to search, via the policy extraction unit, the policy records database, determine, via the policy extraction unit, a plurality of insurance policies that meet the user-entered policy criteria, receive, via a template population unit, an indication of an insurance transaction type, identify, via the template population unit, a template corresponding to the indicated insurance transaction type and including a field for specifying a date indicative of an insurance policy term, and age, via one or more processors, the plurality of insurance policies by modifying the date indicative of the insurance policy term in the field of the template to facilitate testing an implementation of one or more potential changes to the plurality of insurance policies.

### CROSS-REFERENCE TO RELATED APPLICATIONS

This is a continuation of U.S. patent application Ser. No. 14/477,350, entitled “Efficiently Aging and Modifying Policy Records in a Test System” and filed on Sep. 4, 2014, the entire disclosure of which is hereby incorporated herein by reference in its entirety.

### FIELD OF THE DISCLOSURE

The present disclosure generally relates to insurance and, more specifically, to systems and methods for aging and modifying insurance policy data for test purposes.

### BACKGROUND

In home, automobile, and other insurance industries, insurance policy premiums may be typically based upon a large number of business rules (e.g., rules for assigning insurance ratings to an individual, rules for costs to be charged for different insurance ratings, levels of coverage, etc., rules for applying discounts, etc.), which may in turn operate on a large number of factors (e.g., birth date and/or state of residence of the policyholder, claim history of the policyholder, information pertaining to others in the policyholder's household, etc.). If any of these business rules are erroneous, and/or if the business rules fail to contemplate certain scenarios, an insurance provider may inadvertently assess incorrect insurance premiums, which may impose additional costs on the insurance provider. If a policyholder is inadvertently charged too much, for example (e.g., by failing to apply a particular discount, or by failing to take certain information about the policyholder into consideration, etc.), the insurance provider must spend time, money and/or other resources in order to determine the appropriate refund and deliver the refund to the policyholder. Conversely, if a policyholder is charged too little, the insurance provider must either spend resources to determine the deficient amount to be billed to the policyholder, or forego that revenue entirely. To more accurately determine the appropriate premiums at the outset, and thereby decrease the number of subsequent adjustments (e.g., refunds), some insurance providers use test systems that apply proposed business rules to a number of test policies. The hypothetical premiums resulting from the application of the proposed business rules may then be reviewed in depth in order to identify errors in those rules. By identifying such errors in advance, the business rules may be modified before being put into operation/production.

Currently, some insurance providers develop the set of test policies by manually fabricating the data for those policies. This process tends to be very time consuming, however, and may require weeks or months in order to generate data for a sufficiently large number of policies. Moreover, collections of manually fabricated policies will typically fail to accurately reflect the full range and composition of real-world policies (e.g., types of coverage, types of policyholders, etc.). Thus, manually fabricated policies may fail to test some aspects of the business rules that are likely to be utilized once those business rules are put in place. Naturally, this increases the likelihood that errors in the business rules will go undetected, which in turn may increase the likelihood that the insurance provider will incur the costs associated with providing refunds or other subsequent cost adjustments.

### BRIEF SUMMARY

The present embodiments may, inter alia, reduce the time, cost and/or effort of generating test data, and/or more accurately ascertain any errors or issues associated with business rules to be introduced by an insurance provider. The present embodiments may also significantly reduce the time, cost and/or effort associated with providing refunds or other cost adjustments to policyholders, and/or provide other benefits.

In one aspect, a computer system for aging insurance policies stored in a policy records database is configured to: (1) receive, via a policy extraction unit, one or more user-entered policy criteria; use the user-entered policy criteria to search, via the policy extraction unit, the policy records database; (2) determine, via the policy extraction unit, a plurality of insurance policies that meet the user-entered policy criteria; (3) receive, via a template population unit, an indication of an insurance transaction type; (4) identify, via the template population unit, a template corresponding to the indicated insurance transaction type and including a field for specifying a date indicative of an insurance policy term; and/or (5) age, via one or more processors, the plurality of insurance policies by modifying the date indicative of the insurance policy term in the field of the template to facilitate testing an implementation of one or more potential changes to the plurality of insurance policies.

In another aspect, a computer-implemented method of aging insurance policies stored in a policy records database comprises: (1) receiving, via one or more processors, one or more user-entered policy criteria; (2) using the user-entered policy criteria to search, via the one or more processors, the policy records database; (3) determining, via the one or more processors, a plurality of insurance policies that meet the user-entered policy criteria; (4) receiving, via the one or more processors, an indication of an insurance transaction type; (5) identifying, via the one or more processors, a template corresponding to the indicated insurance transaction type and including a field for specifying a date indicative of an insurance policy term; and/or (6) aging, via the one or more processors, the plurality of insurance policies by modifying the date indicative of the insurance policy term in the template to facilitate testing an implementation of one or more potential changes to the plurality of insurance policies.

In another aspect, a computer-implemented method of simulating a financial performance of a modification to an insurance policy comprises: (1) modifying a premium, rate, discount, rebate, reward, coverage, coverage amount, deductible, or other condition associated with an insurance policy that impacts a financial performance of the insurance policy; (2) creating a virtual template that holds insurance policy data elements, the insurance policy data elements including a policy number, a policy expiration date, and an insurance premium, rate, discount, rebate, reward, coverage, coverage amount, or deductible; (3) using the virtual template to adjust one or more of the insurance policy data elements to a specific value to trigger one or more insurance-related event or otherwise to age the insurance policy; (4) determining a financial impact of the insurance-related event on the financial performance of the insurance policy; and/or (5) verifying that the financial impact of the insurance-related event on the financial performance of the insurance policy was as expected such that an accuracy of the modification to the insurance policy is tested before being implemented.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 depicts an exemplary environment including components associated with aging, modifying and/or testing policy records, according to one embodiment.

FIG. 2 depicts an exemplary process flow for aging, modifying and/or testing policy records, according to one embodiment.

FIG. 3 depicts an exemplary template used to automatically generate each of multiple input files, according to one embodiment.

FIG. 4 depicts the exemplary template of FIG. 3 after being automatically populated with information corresponding to a first policy, according to one embodiment and scenario.

FIG. 5 depicts the exemplary template of FIG. 3 after being automatically populated with information corresponding to a second, different policy, according to one embodiment and scenario.

FIG. 6 depicts a flow diagram of an exemplary method for testing business rules using a plurality of insurance policies, according to one embodiment.

FIG. 7 depicts a flow diagram of an exemplary method for automatically generating an input file to be tested, according to one embodiment.

FIG. 8 depicts a flow diagram of an exemplary method for processing an input file according to a set of business rules, according to one embodiment.

FIG. 9 depicts an exemplary computer system in which the techniques for aging, modifying and/or testing data for a plurality of insurance policies described herein may be implemented, according to one embodiment.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, updating and/or modifying a large number of insurance policies. Insurance rates, premiums, policy conditions, and so forth may change for a substantial number of insurance policies issued by an insurance provider. For instance, insurance may be regulated by individual states within the U.S. A change in state law or regulation may lead to a substantial number of insurance policies within a given state needing to be adjusted at the same time or within a given period of time.

In one aspect, the present embodiments may include an automated process that tests a batch of insurance policies to be renewed and/or converted by creating large-volume billing transactions using “reduced data.” The process may introduce an efficient method to test renewals and/or conversions using enormous volumes of real policy data compared to the smaller volumes of fabricated data of conventional techniques. The result may be a much more inclusive review and robust test of policy scenarios. The process may ultimately ensure a greater degree of rating accuracy within a portfolio of insurance policies. The concepts of the process may be used not only for auto policy data aging, but with other types of insurance (home owners, renters, life, health, etc.) and test data.

Various aspects of the present embodiments may include a virtual template displayed on a computer screen. The virtual template may serve as a product model containing the data elements of the policy data along with household data elements. The template may be used to model a large collection of data from different policies in a test system or environment. Macros and/or scripts may be run on this model to make changes and/or perform several operations, including (1) setting specific data elements to specific values to trigger test scenarios; and may include (2) setup metadata that may guide insurance policies through a renewal cycle; (3) setup metadata that may guide insurance policies through a policy change transaction; (4) setup metadata that may guide policies through a cancellation transaction; (5) setup metadata that may guide policies through a reinstatement transaction; and/or (6) setup metadata that may guide policies through an endorsement transaction.

The process may select only the requested policies for testing, preventing other policies in the system from being included in the test run and causing noise in the test results. The process may be integrated with a tool that queries scrubbed production test data, and/or include an ability to update the policy data within the system by application of the automated input. The process may also be integrated with a tool that injects the output of the solution into a test system.

In one embodiment, the process may involve aging insurance policy data and/or aging insurance policies, and/or then using the aged insurance policy data or policies to check the accuracy of proposed modifications to insurance policies, premiums, rates, rebates, programs, coverages, etc. As an example, an “auto policy master record data” may be involved with the process taking a current set of insurance policies from captured auto policies that are active as of a current date and “renewing” them multiple times to have those polices look and act (to a computer system or test environment) as if they are still active in the future (and after changes to an insurance policy go into effect) such that the insurance provider may test future dated rating changes against that data correctly.

The process may also involve using reduced data. As an example, an insurance provider testing area or environment may capture all critical data from various operation centers and provide a smaller set of that data to test any new or changed processing against that data. The smaller set of data may be considered the reduced data.

The process may involve using one or more virtual templates. For instance, a template may facilitate or provide for a single generic input transaction that may be automatically duplicated to process against all policies extracted from a database of policies and/or otherwise identified.

The process may involve using a repository. The repository may house or store a collection of transactional (virtual) templates that may be quickly deployed for the production of test case data unique to the business client present in any state jurisdiction. Utilizing the process may enable automation to select a large volume of data which accurately represents the natural variety of customer, policy, and/or household characteristics along with producing the desired set of targeted test data scenarios.

Future insurance policy changes may be tested for accuracy in volume before they “go live.” For instance, the process to age auto reduced data may allow for more use of actual policy data and/or less reliance on fabricated data to test future dated rate level processing in volume.

The process may (i) remove the need for the manual update of the data elements; (ii) include integration with a tool that mines policy and household data, and/or a another tool that injects the model into the system under test; (iii) include building a template or model of the data elements at that initial state; and/or (iv) provide the ability to run scripts or macros to update that model, and/or the ability to specify metadata to steer the policy into a specific transaction.

### I. EXEMPLARY EMBODIMENTS

Conventional techniques may have provided insufficient testing that ultimately failed to ensure that common policy scenarios were accounted for when an insurance provider implemented rate adjustments. The test data typically was manually fabricated using nearly identical policy scenarios. The absence of a comprehensive repository of repeatable test cases meant that less common scenarios were not tested. This is problematic with today's record keeping demands that may require an insurance provider to account for varied configurations of customer household and auto policy data.

Also, a very limited amount of fabricated test data and test input was previously manually created for bill renewals to review the impacts of any new rate change. This manually created data may not adequately represent the variety of real scenarios that would be required to test system changes thoroughly. Test results from this approach were not as precise or comprehensive as desired.

Conventionally, insurance providers may have kept most auto policy data in a policy master record (PMR) database. In production, policies age by way of billing renewals (usually every 6 months). Most renewal billings may be processed automatically using a “Pending” process where the system keeps track of when the new term starts and then sends out the bill usually 34 days in advance. The billing may also be “manually” created for individual policies by operators making an entry for an “Irregular Billing” transaction.

In testing, previously there has been no automated process to bill (age) large volumes of policies using either method. Conversely, in one embodiment, the present embodiments include an automated way to create “Irregular Billing” transactions such that even large volumes of policies may be aged in testing.

The present embodiments provide a tool that may extract (or identify) Auto Policies from a large Reduced Data Database and create an “Irregular Billing” transaction for each of the policies extracted. The process to create transactions to process against all the policies extracted is believed to be unique.

The “Irregular Billing” transactions may be created for each policy by using a single transactional template which is a generic Irregular Billing transaction not tied to a particular policy. When the extraction is performed, the policy number and expiration date as well as some other necessary data/information may be loaded into a copy of the template. The template may be copied for every policy extracted with the particular data unique to each policy loaded into the template. Therefore, by performing an extract of policies, renewal transactions may be automatically created for hundreds or thousands of policies.

By implementing the process mentioned above, the present embodiment, in one aspect, have automated what used to be a very time-intensive manual process to create Auto Policy renewal transactions allowing large volumes of policies to be processed.

As shown in Table 1 above, a process of creating aged test data may be provided. The process may include determining if insurance policy data aging is needed; deciding how many policy terms to advance the data; creating an extract of policies to age from reduced policy data; extracting policies from a database; creating renewal transactions from a template; processing renewal transactions against policies; and/or yielding aged test data to facilitate verifying the accuracy of modifications to insurance policies and/or rates. The process may include additional, fewer, or alternate actions, including those discussed elsewhere herein.

In another aspect, a method of a testing an updated insurance policy may be provided. The method may include (1) updating an insurance policy, such as updating a rate, premium, or discount for an insurance policy or updating a type of insurance policy in general to comply with new state regulation. The method may include (2) generating a virtual template that simulates financial and/or other performance of the insurance policy in the future once the changes to the insurance policy go into effect. The virtual template may facilitate triggering various test scenarios, such as running updated insurance policies through renewal cycles, change transactions, cancellation transactions, reinstatement transactions, and/or endorsement transactions. For instance, the virtual template may allow for changing the expiration date insurance policy further out into the future to test effectiveness of an updated insurance policy or rate on fact patterns of specific insureds, such as whether individuals are single, married, young, older, etc. The method may also include (3) verifying the rate and/or changes to the insurance policy were changed correctly by comparing expected results with the actual results shown via the testing. As a result, insurance policy and/or rate (or premium, discount, etc.) changes may be verified before being implemented and before inaccurate policy changes are inadvertently sent out to customers, thus alleviating customer dissatisfaction and/or annoyance, and/or billing errors. Further, more accurate revenue forecasts associated with insurance premiums being received by an insurance provider after insurance policy changes are implemented may be facilitated via the testing.

In another aspect, a computer-implemented method of simulating a financial performance of a modification to an insurance policy may be provided. The method may include (1) modifying a premium, rate, discount, rebate, reward, coverage, coverage amount, deductible, or other condition associated with an insurance policy that impacts a financial performance of the insurance policy; (2) creating a virtual template that holds insurance policy data elements, the insurance policy data elements including a policy number, a policy expiration date, and an insurance premium, rate, discount, rebate, reward, coverage, coverage amount, or deductible; (3) using the virtual template to adjust one or more of the insurance policy data elements to a specific value to trigger one or more insurance-related event or otherwise to age the insurance policy; (4) determining a financial impact of the insurance-related event on the financial performance of the insurance policy; and/or (5) verifying that the financial impact of the insurance-related event on the financial performance of the insurance policy was as expected such that an accuracy of the modification to the insurance policy is tested before being implemented. The one or more insurance-related events may include an insurance policy renewal, change, cancellation, reinstatement, or endorsement; and the insurance policy may be an auto, home owners, renters, life, or health insurance policy. The method may include additional, fewer, or alternate actions, including those discussed elsewhere herein.

### II. EXEMPLARY AGING, MODIFYING AND TESTING OF POLICY RECORDS

The present embodiments may relate to automated aging and modifying of insurance policy data/records for testing purposes. The insurance policies may be automobile insurance policies, home insurance policies, personal property insurance policies, life insurance policies, and/or any other type of insurance policy. The policies of interest may be aged (and, in some embodiments and scenarios, modified) in order to test a set of proposed business rules, such as new insurance rating rules, new rules for pricing structures, and/or rules reflecting state or federal legislation that will go into effect at a future date, for example. Once the aged policies have been processed according to the proposed business rules, the insurance provider may conduct an in-depth review of the resulting insurance premiums, surcharges, discounts, and/or other costs associated with the aged policies. If any errors are identified (e.g., incorrect premiums for particular policies), the business rules may be modified to eliminate the source of the error(s), thereby preventing the issue from recurring when the business rules are put into operation. As a result, the insurance provider may more accurately bill customers/policyholders, without necessarily requiring that a large number of extra charges or refunds be determined or distributed, and without necessarily foregoing revenue due to the insurance provider.

In some embodiments, to ensure that this testing process considers policies reflecting relatively common, real-life scenarios, the aged policy data may be generated based upon the real policies of actual policyholders/customers of the insurance provider. Moreover, to ensure that the testing process considers a wide range of policy scenarios, the aged policy data may be generated from a large number of these policies in an automated manner. To this end, the system may utilize one or more “templates” that arrange a limited set of policy information in a predefined format that is known a priori by the test system. Each template may correspond to a particular type of insurance transaction, such as a renewal transaction, a coverage change transaction (e.g., adding or removing comprehensive coverage, adding or removing an endorsement/rider, etc.), a termination transaction, a reinstatement transaction, etc. For example, a template for a renewal transaction may include a first field for information that uniquely identifies a policy (e.g., the policy number) and a second field for information indicating the date of the renewal (e.g., six months after the most recent term of that particular policy began, 12 months after the most recent term began, six months after the most recent term of that particular policy expired, etc.). As another example, a template for a coverage change transaction may include a first field for information that uniquely identifies a policy, a second field for information indicating the date of a future policy term during which the coverage change will take effect, and a third field specifying the coverage change being implemented.

For each policy of interest (e.g., each policy, in a policy records database, that meets a set of search criteria), a copy of the desired template may be automatically generated. Information associated with that policy (e.g., state, policy number, effective date of the most recent term, etc.) may then be automatically retrieved to populate the fields of the template copy. The populated template copy may then serve as an input file to a test system that recognizes the format of the input file (e.g., the format and definitions of the template fields) and processes the input file according to a set of business rules/logic. In some embodiments and/or scenarios, each input file (populated template copy) may be subject to additional processing before being processed by the test system. For example, one or more macros may be used to advance the date/term by an additional amount, to change a type of coverage specified in the template, and/or to change other information specified in the template. In some embodiments, to further protect the personal information of policyholders, the template may include information identifying the policyholder (e.g., name, address, etc.), and macros may anonymize the identifying information prior to testing by the test system.

In some embodiments and/or scenarios, two or more input files are generated for each policy of interest. For example, a renewal template may be used to generate a first input file advancing a particular policy one term into the future, and a macro may operate on the first input file to generate a second input file advancing the policy a second term into the future. Both the first and the second input file may then be processed by the test system to determine the hypothetical premiums associated with each term, for example. Moreover, in some embodiments and/or scenarios, two or more different types of templates are used for each policy of interest. For example, a coverage change template may be used for a particular policy to add a type of coverage and advance the policy one term into the future, and a renewal template may be used to advance the policy (with the new coverage in place) a second term into the future.

By generating input files in an automated manner, and based upon real-world policies, an insurance provider may quickly and efficiently test a wider, more realistic range of policy scenarios. As a result, the insurance provider may more accurately determine premiums or other insurance policy costs, leading to fewer refunds or other billing adjustments.

### III. EXEMPLARY ENVIRONMENT FOR AGING, MODIFYING AND TESTING POLICY RECORDS

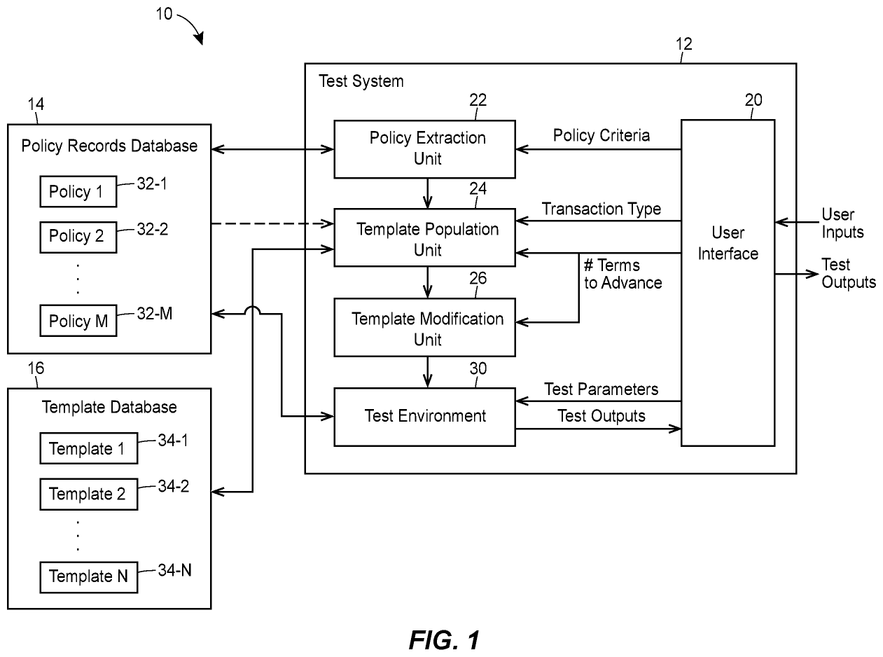

FIG. 1 depicts an exemplary environment 10 including components associated with aging, modifying and/or testing policy records, according to an embodiment. As illustrated in FIG. 1, the exemplary environment 10 may include a test system 12, a policy records database 14, and/or a template database 16. Test system 12, policy records database 14, and template database 16 may be associated with an insurance provider, such as a provider of vehicle, home, personal property, and/or life insurance, for example. Test system 12 may include a user interface 20 that allows a user/operator to interact with test system 12. The user may provide inputs to user interface 20 using one or more input devices not shown in FIG. 1, such as a keyboard and/or mouse, for example. The user may also receive/view outputs from user interface 20 using one or more output devices not shown in FIG. 1, such as a monitor, for example. In some embodiments, user interface 20 supports interaction between test system 12 and multiple users (e.g., users at multiple user terminals that are communicatively coupled to test system 12).

Test system 12 may also include various units to collect and age/modify policy data for testing. In the environment 10, for example, test system 12 may include a policy extraction unit 22, a template population unit 24, and/or a template modification unit 26. In general, in one embodiment, policy extraction unit 22 extracts policies of interest from policy records database 14, template population unit 24 retrieves templates from template database 16 and populates copies of the templates based upon information associated with extracted policies, and template modification unit 26, in at least some scenarios, applies macros or other processing to the populated template copies in order to change information entered in the fields of the populated template copies (e.g., term dates, coverage types, etc.). Test system 12 may also include a test environment 30, which generally processes input files (e.g., populated template copies) generated by template population unit 24 (and possibly modified by template modification unit 26) according to a set of business rules/logic, in an embodiment.

Policy records database 14 and template database 16 may each be stored in a respective non-volatile memory, such as a hard drive memory, solid state read-only memory (ROM), and/or a removable memory (e.g., flash drive, etc.), for example. Alternatively, policy records database 14 and template database 16 may both be stored in the same memory, or may each be distributed across multiple memories. Policy records database 14 may include policy entries 32-1 through 32-M, where each of the policy entries 32 may be associated with a respective one of M different insurance policies, and where M is an integer greater than one (e.g., a number in the hundreds, thousands, hundreds of thousands, etc.). Each of policy entries 32-1 through 32-M may include coverage information for the respective policy (e.g., types of coverage under the policy, limits of the coverage(s), deductibles for the coverage(s), etc.), and/or information associated with a policyholder of the respective policy (e.g., name, birth date, gender, state of residence, street address, occupation, information about other household members, etc.), for example. In some embodiments, the information stored in policy records database 14 may be a set of “reduced” data extracted from a larger, more complete policy records database. The policy records database 14 may omit information not considered likely to be useful for testing purposes, for example (e.g., names of policyholders or personal information).

Template database 16 includes templates 34-1 through 34-N, where each of the templates 34 may correspond to a respective one of N different types of insurance transactions, and where N is an integer greater than or equal to one (e.g., one, two, five, 10, etc.). For example, template 34-1 may correspond to a renewal transaction, template 34-2 may correspond to a coverage change transaction, template 34-3 may correspond to a policy termination transaction, template 34-4 may correspond to a policy reinstatement transaction, etc. Each of templates 34-1 through 34-N may be a respective file conforming to a format that is predefined for that particular template. If template 34-1 corresponds to a renewal transaction, for example, the template 34-1 may include a first field designated for information that uniquely identifies an insurance policy, and a second field designated for information indicative of a future term of the insurance policy (e.g., the future term at which the renewal is being modeled). As another example, if template 34-2 corresponds to a coverage change transaction, the template 34-2 may include a first field designated for information that uniquely identifies an insurance policy, a second field designated for information indicative of a future term of the insurance policy (e.g., the future term in which the coverage change is being modeled as first taking effect), and a third field designated for information indicating a type of coverage and whether that coverage is being added, removed or modified in a particular way. Alternatively, the third field may indicate only a type of coverage, with the test environment 30 knowing a priori that the indicated coverage is to be added, removed, or modified in a particular way.

The test system 12 may be, or include, one or more processors of one or more computing devices, such as one or more servers, for example. In one embodiment, each of user interface 20, policy extraction unit 22, template population unit 24, template modification unit 26, and/or test environment 30 may be (or may include) a respective set of one or more processors. Alternatively, in an embodiment, each of some or all of user interface 20, policy extraction unit 22, template population unit 24, template modification unit 26, and/or test environment 30 in FIG. 1 may be a component of software stored on a computer-readable medium (e.g., a random access memory (RAM) and/or ROM of test system 12) and executed by one or more processors of test system 12. User interface 20 may also include dedicated hardware, such as a graphics card, for example. In some alternative embodiments, the environment 10 may include additional, fewer, and/or different components than shown in FIG. 1. In various embodiments, for example, the test system 12 does not include policy extraction unit 22 (e.g., if all policy entries 32 in policy records database 14 are routinely utilized for testing), and/or does not include template modification unit 26 (e.g., if the templates 34 available in template database 16 are sufficiently numerous/diverse to cover all desired testing scenarios, without requiring any modification of the populated template information).

The operation of test system 12 will now be described, according to one embodiment. Initially, a user/operator may provide, via an input device (e.g., keyboard) and user interface 20, one or more criteria of policies that the user desires to age and test. For example, the user may specify that only policies effective within a certain state or states should be utilized, and/or that only policies having (or lacking) a certain type of coverage should be utilized, etc. The user may also provide an indication of a transaction type to be modeled for testing, and/or an indication of a number of terms to advance/age each policy for testing. The indication of transaction type may be text associated with the transaction type (e.g., “RENEWAL”), or an identifier of a template known to correspond to the transaction type (e.g., “TEMP00” to represent a renewal, “TEMP01” to represent a coverage change, etc.), for example.

Based upon the entered policy criteria, policy extraction unit 22 may retrieve from policy records database 14 all policies matching the criteria. In some embodiments, policy extraction unit 22 may retrieve all data in those entries, of entries 32, that correspond to matching policies. Alternatively, policy extraction unit 22 may simply output an identifier of each matching entry (e.g., the policy number of matching entry, and/or other information sufficient to uniquely identify the policy), without retrieving all of the corresponding data.

Policy extraction unit 22 may then provide the policy data for the extracted policies, and/or the identifiers of the extracted policies, to template population unit 24. Template population unit 24 may also use the transaction type indicator entered by the user to retrieve the corresponding one of templates 34 from template database 16. For each extracted policy, template population unit 24 may automatically generate a copy of the retrieved template, and automatically populate at least one of the fields of the template copy with information specific to that policy. For a renewal transaction template having the first and second fields described above, and in a scenario where the policy corresponding to policy entry 32-1 is extracted by policy extraction unit 22, for example, template population unit 24 may populate the first field of the template copy with the policy number included in policy entry 32-1 (and/or other information, such as the state and division of the policy, etc.), and populate the second field of the template copy with the date of a future term for the policy. The future date may be calculated based upon the date of a current or past term of the policy, e.g., by adding an integer number of term lengths to an effective date (or expiration date) stored in the policy entry 32-1. In some embodiments, the number of terms to advance the term date is a number entered by a user via an input device (e.g., keyboard) and user interface 20. Template population unit 24 may automatically generate template copies, and populate the generated template copies with policy-specific information, for some or all of the policies extracted by policy extraction unit 22.

Each populated template copy may be used as an input file to be processed by test environment 30. In some embodiments and/or scenarios, however, some or all of the populated template copies are modified by template modification unit 26 prior to processing by test environment 30. For example, template modification unit 26 may include or execute one or more macros that automatically advance the future term date in the corresponding field of each template copy by the amount indicated by the user. Alternatively, template database 16 may include a different template 34 for each number of terms that the term date can possibly be advanced, and template population unit 24 may retrieve the appropriate template in part based upon the user's indication of the number of terms to advance the date.

As another example, in an embodiment and scenario where the selected template includes a field designated for indicating a particular type of coverage associated with the policy, template modification unit 26 may change the field information in each populated template copy to reflect a different type of coverage. As yet another example, in an embodiment and scenario where the selected template includes one or more fields designated for indicating information identifying a policyholder of the policy (e.g., name, address, etc.), template modification unit 26 may change the identifying information in each populated template to preserve policyholder anonymity. Alternatively, template population unit 24 itself may anonymize such information, e.g., by including one or more fields corresponding to identifying information, and automatically populating those fields with fictitious names, addresses, etc. in each template copy. Generally, template modification unit 26 may provide a user with increased flexibility (e.g., allow a wider range of input files to be created than might otherwise be possible using only the various fields of templates 34).

Operation has been described thus far with respect to an embodiment and scenario in which a single input file (e.g., a single populated template copy, with or without subsequent modification by template modification unit 26) may be generated for each extracted policy. In other embodiments and/or scenarios, however, two or more input files may be generated for each extracted policy. If the user indicates that policy data is to be advanced by four terms, for example, four input files may be generated for each extracted policy (e.g., a first input file advancing the policy one term, a second input file advancing the policy two terms, a third input file advancing the policy three terms, and a fourth input file advancing the policy four terms). In various embodiments, each of these input files for a given policy may be generated using a copy of a different template (e.g., using a copy of a first template for advancing the policy one term, using a copy of a second template for advancing the policy a second term, etc.), by applying a same template multiple times in serial fashion (e.g., using a copy of a particular template to advance the policy one term, then using another copy of the same template to advance the already-advanced policy by one additional term, etc.), or by applying a macro to a single, populated copy of a template.

Moreover, in some embodiments and scenarios, multiple input files may be generated for a single policy both by using multiple templates and processing the populated template copies using a macro. For example, a user may wish to extract all policies that do not have comprehensive coverage, add comprehensive coverage to those policies, and model and test those policies at one term in the future, two terms in the future, and/or three terms in the future. To this end, policy extraction unit 22 may retrieve from policy records database 14 all policies not having comprehensive coverage, and template population unit 24 may retrieve from template database 16 two templates: a first template corresponding to a coverage change transaction, and a second template corresponding to a renewal transaction. In this embodiment and scenario, template population unit 24 may, for each extracted policy, populate a copy of the first (coverage change) template with an identifier of the policy, the effective date of the next policy term (e.g., the date when the coverage is to be added), and an indication that comprehensive coverage is being added to the policy. Template population unit 24 may then use the populated copy of the first template to populate a copy of the second (renewal) template, with one additional term added to the future term date. Template modification unit 30 may then twice apply, to the populated copy of the second template, a macro that advances the future term date field by one term (e.g., six months). Test environment 30 may then use the populated copies of the first and second templates as first and second input files (i.e., terms one and two), respectively, process the populated second copy of the template with the macro to generate a third input file (i.e., term three), and further process the populated and macro-processed second copy of the template to generate a fourth input file (i.e., term four). In an embodiment, insurance policy modifications introduced by a template may propagate through additional processing, if any, that is performed by template population unit 24 and/or template modification unit 26. With respect to the four input files described above, for example, the comprehensive coverage added for the first input file may also be reflected in the second, third and fourth input files.

Test environment 30 may process the input files (e.g., one or more populated template copies per extracted policy, each with or without modification by template modification unit 26) using software instructions that represent a set of business rules. To provide just a few examples, the business rules may include proposed rules setting premiums for different types of coverage/ratings, proposed rules for rating customers (e.g., based upon demographics, claims history, accident history, traffic violation history, etc.), and/or proposed rules reflecting expected state or federal legislation (e.g., legislation capping deductibles at a new amount, legislation raising out-of-pocket maximum amounts, etc.). In some embodiments, the business rules applied by the test environment 30 may be fully determined and/or coded prior to policy extraction unit 22 extracting desired policies. In other embodiments, some business rules may be fixed at that time, while other business rules may be set based upon test parameters input by the user (e.g., via a keyboard and user interface 20) prior to testing (e.g., at the time that the policy criteria are entered). For example, the user may enter the name of a particular file that may contain premiums for different levels of coverage, and the test environment 30 may apply those premiums as a part of the business rules. In an embodiment, the processing performed by test environment 30 may substantially replicate the “end-of-day” batch processing of policy information/transactions that may typically be performed by insurance providers.

Test environment 30 may generate one or more test outputs based upon the processing of the input files. For example, test environment 30 may generate one output file for each processed input file, generate one output file for each group of input files associated with a particular policy, generate a single output file indicating the test outputs for all input files, etc. The test outputs may indicate costs associated with the aged policies (e.g., premiums, discounts, etc.) when the business rules are applied. The test outputs may be carefully reviewed (e.g., manually by one or more human operators) to determine whether any of the indicated costs are incorrect. If so, the business rules may be modified to remedy the problem. In some embodiments and/or scenarios, test environment 30 may then use the revised business rules to again test the input files. The test outputs may then be manually reviewed a second time, with the process continuing in an iterative fashion until a particular level of confidence is achieved and the business rules may be implemented with respect to actual customer policies.

### IV. EXEMPLARY PROCESS FLOW FOR AGING, MODIFYING AND TESTING POLICY RECORDS

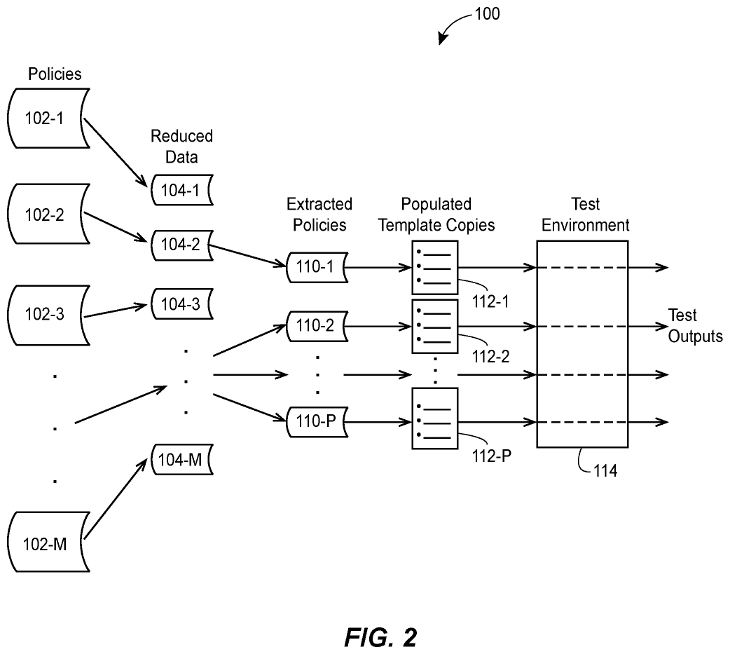

FIG. 2 depicts an exemplary process flow 100 for aging, modifying and/or testing policy records, according to an embodiment. The process flow 100 may be implemented by components of the environment 10 of FIG. 1, for example. In the process flow 100, each of multiple sets of policy data 102-1 through 102-M may include detailed information about the policy itself (e.g., coverage types, deductibles, limits, etc.), as well as policyholder information associated with the policy (e.g., age, gender, name, address, information about other household members, claims history, accident history, etc.). Key parameters within this information may be extracted and used to generate corresponding sets of “reduced” policy data 104-1 through 104-M. The sets of reduced policy data 104-1 through 104-M may omit certain types of information, in the sets of policy data 102-1 through 102-M, that are considered to be less useful or useless for testing purposes. For example, the sets of reduced policy data 104-1 through 104-M may omit address history data (e.g., prior residences), names, and/or other information included in the sets of policy data 102-1 through 102-M. In one embodiment, the sets of reduced policy data 104-1 through 104-M are stored as the policy entries 32-1 through 32-M in policy records database 14 of FIG. 1.

Based upon criteria entered by the user, sets of extracted policy data 110-1 through 110-P may be identified, where P may be an integer less than or equal to M. In some embodiments, the sets of extracted policy data 110-1 through 110-P are copied from the matching sets of the sets of reduced policy data 104-1 through 104-M. In other embodiments, the sets of extracted policy data 110-1 through 110-P are not generated as new copies/files, but instead are indicators/identifiers (e.g., policy numbers) representing those data sets, of the sets of reduced policy data 104-1 through 104-M, that match the search criteria.

For each of the sets of reduced policy data 104-1 through 104-M, a copy of the appropriate (e.g., user-selected) template may be automatically generated and populated with information included in the respective one of sets 104-1 through 104-M, resulting in a respective one of populated template copies 112-1 through 112-P. The populated template copies 112-1 through 112-P may then be used as input files for a test environment 114 that applies a set of business rules, and generates test outputs (e.g., calculated premiums) for each input file. The test environment 114 may be the same as, or similar to, test environment 30 of FIG. 1, for example. In other embodiments, two or more templates (e.g., each corresponding to a different transaction type) are copied and populated for each of the sets of extracted policy data 110-1 through 110-P prior to testing, and/or some or all of the populated template copies 112-1 through 112-P are modified (e.g., using macros) prior to testing.

### V. EXEMPLARY TEMPLATE FOR GENERATING INPUT FILES

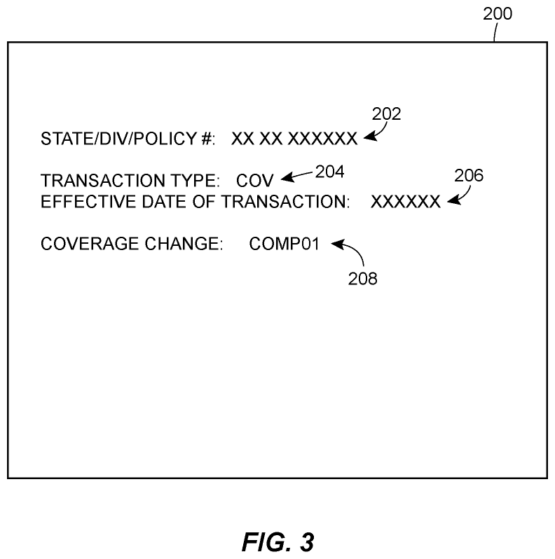

FIG. 3 depicts an exemplary template 200 used to automatically generate each of multiple input files, according to an embodiment. More specifically, the template 200 is an example of a template that may be used to model a change in coverage for an insurance policy. The template 200 may be one of the templates 34 stored in template database 16 of FIG. 1, for example. FIG. 3 depicts the template 200 as it may appear to a user if displayed on a monitor via a user interface such as user interface 20 of FIG. 1, for example. It is understood, however, that the displayed template 200 does not necessarily reflect the arrangement of information/data within a file representing the template 200. For example, the template file may include binary or hexadecimal data without any human-readable text associated with the various fields.

In the embodiment of FIG. 3, the exemplary template 200 may include a first field 202, a second field 204, a third field 206 and/or a fourth field 208. In other embodiments, however, the template 200 may include more or fewer fields. The first field 202 may be reserved for information that uniquely identifies a policy. In the embodiment shown in FIG. 3, for example, the first field 202 may be reserved for a two-digit or two-character state code (e.g., state in which the policy is implemented), a two-digit or two-character division code (e.g., division of the insurance provider handling the policy), and/or a six-digit or six-character policy number. In other embodiments, the first field 202 may be reserved for more information, less information, and/or different information identifying the policy. For example, the first field 202 may be reserved only for the policy number.

The second field 204 may be reserved for the type of insurance transaction being modeled. In the embodiment shown in FIG. 3, the type of insurance transaction (coverage change) may be fixed for the template 200, and the second field 204 therefore includes, for all policies using the template 200, a fixed value (“COV”) specifying that type of transaction. The third field 206 may be reserved for the date on which the transaction is being modeled as taking effect. In the embodiment shown in FIG. 3, the third field 206 may be reserved for a six-digit date code (e.g., MM/DD/YY), which may mark the beginning of a future policy term in which the transaction is modeled as taking effect, for example.

The fourth field 208 may be reserved for the type of coverage change being modeled for the policy. In the embodiment shown in FIG. 3, the fourth field 208 may be reserved for a five-digit or five-character code representing the type of coverage to be added, removed and/or otherwise modified in the model. The fourth field 208 may be designated as specifying a coverage to be added, specifying a coverage to be removed, or specifying both the coverage type and whether that coverage is to be added or removed, for example. In some embodiments, the value of the fourth field 208 is, like the value of the second field 204, fixed for all policies. In the exemplary embodiment of FIG. 3, for example, the fourth field 208 has the fixed value “COMP01” to model comprehensive coverage as being added to (or removed from) each policy that uses the template 200.

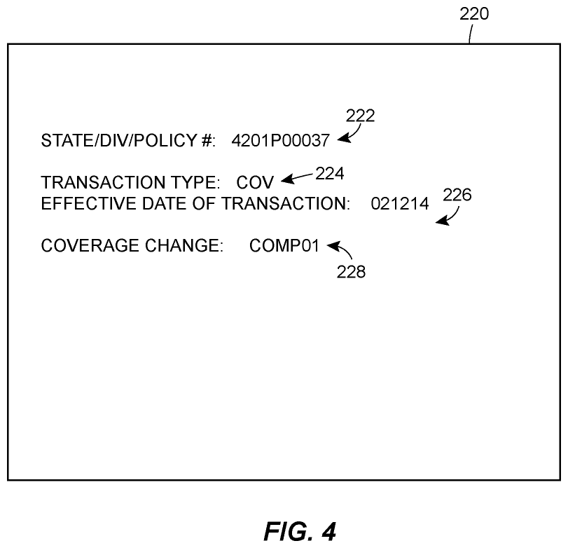

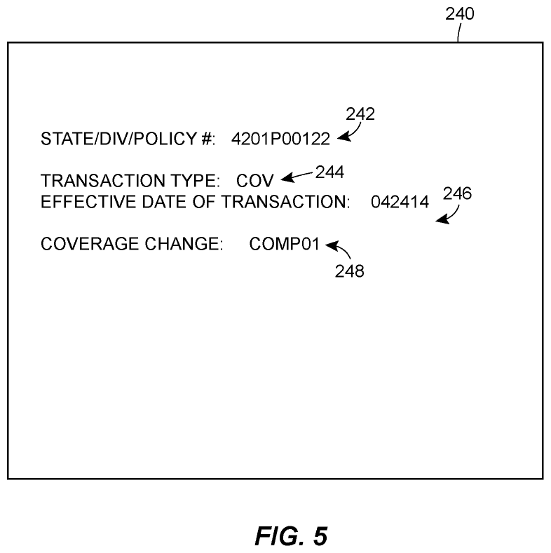

The template 200 may be automatically reproduced and populated (e.g., by template population unit 24) for each policy of interest (e.g., each policy extracted by policy extraction unit 22). Examples of the template 200, when reproduced and populated, are provided in FIGS. 4 and 5, described below. The template copies of FIGS. 4 and 5 may correspond to policies that were extracted in response to meeting certain search criteria (e.g., a particular state, a particular division, having or lacking comprehensive coverage, etc.), for example. It is understood that, as with the template 200, the displayed template copies of FIGS. 4 and 5 do not necessarily reflect the arrangement or type of information/data within the files representing the template copies.

A. Exemplary First Populated Template

FIG. 4 depicts a first populated template copy 220, which corresponds to the exemplary template 200 of FIG. 3 after being populated with information corresponding to a first policy, according to one embodiment and scenario. The first policy may be the policy corresponding to policy entry 32-1 of FIG. 1 or data set 110-1 of FIG. 2, for example. As seen in FIG. 4, the template copy 220 may include four fields, each corresponding to a respective one of the four fields of the template 200 of FIG. 3. Specifically, in this embodiment/scenario, the first field 202 of template 200 may be reproduced as a first field 222 in the template copy 220, which is populated with the information “4201P00037.” For example, “42” may be a code specifying the state in which the first policy operates (e.g., Illinois, Ohio, etc.), “01” may be a code specifying the division of the insurance provider that handles the first policy, and “P00037” may be the policy number of the first policy. The state, division and policy number may be retrieved from one of policy entries 32 corresponding to the first policy (e.g., policy entry 32-1), for example.

The second field 204 of template 200 may be reproduced as a second field 224 in the template copy 220, and in this example remains at the fixed value “COV.” The third field 206 of template 200 may be reproduced as a third field 226, which may be populated with the information “021214” to indicate that the coverage change transaction is being modeled as occurring on Feb. 12, 2014 (or at the beginning of a term expiring on that date, etc.). The date may have been calculated based upon the start or expiration date of a current, or most recent, term of the first policy, which in turn may have been retrieved from one of policy entries 32 corresponding to the first policy (e.g., policy entry 32-1), for example. The fourth field 208 of template 200 may be reproduced as a fourth field 228, which in this example remains at the fixed value “COMP01.”

The populated template 220 may then be processed according to the business rules of a test environment (e.g., test environment 30). In some embodiments, the populated template 220 may be modified by one or more macros before being processed according to the business rules of the test environment. For example, the division in the first field 222 may be changed, the date in the third field 226 may be advanced (or turned back) by one or more terms, and/or the type of coverage change in the fourth field 228 may be modified. Regardless of whether any modification of field values occurs, the test environment may know a priori the definitions of the information in each of fields 222, 224, 226 and 228, and therefore apply the business rules to that information in the appropriate fashion. For example, the business rules may use the information in field 222 to retrieve more detailed coverage information for the policy, use the date in field 226 to determine how long ago a previous claim or accident occurred, use the information in field 228 to determine the type of coverage being changed, use the information in field 224 to determine whether that coverage is being added or removed, etc. In particular, the test environment may calculate a premium for the holder of the policy. For example, the test environment may calculate the predicted premium for a term having an effective date equal to the date in field 226.

B. Exemplary Second Populated Template

FIG. 5 depicts a second populated template copy 240, which corresponds to the exemplary template 200 of FIG. 3 after being populated with information corresponding to a second, different policy, according to one embodiment and scenario. The second policy may be the policy corresponding to policy entry 32-2 of FIG. 1 or data set 110-2 of FIG. 2, for example. As seen in FIG. 5, the template copy 240 (like template copy 220) may include four fields, each corresponding to a respective one of the four fields of the template 200 of FIG. 3. Specifically, in this embodiment/scenario, the first field 202 of template 200 is reproduced as a first field 242 in the template copy 240, which may be populated with the information “4201P00122.” As with the template copy 220, “42” may be a code specifying the state in which the second policy operates, “01” may be a code specifying the division of the insurance provider that handles the second policy, and “P00122” may be the policy number of the second policy. The state, division and policy number may be retrieved from one of policy entries 32 corresponding to the second policy (e.g., policy entry 32-2), for example.

The second field 204 of template 200 may be reproduced as a second field 244 in the template copy 240, and in this example remains at the fixed value “COV.” The third field 206 of template 200 may be reproduced as a third field 246, which may be populated with the information “042414” to indicate that the coverage change transaction is being modeled as occurring on Apr. 24, 2014 (or at the beginning of a term expiring on that date, etc.). The date may have been calculated based upon the start or expiration date of a current, or most recent, term of the second policy, which in turn may have been retrieved from one of policy entries 32 corresponding to the second policy (e.g., policy entry 32-2), for example. The fourth field 208 of template 200 may be reproduced as a fourth field 248, which in this example remains at the fixed value “COMP01.”

The populated template 240 may then be processed according to the business rules of the same test environment that processed populated template 220. As with the populated template 220, in some embodiments, the populated template 240 may be modified by one or more macros before being processed according to the business rules of the test environment. Moreover, the test environment may again apply its knowledge of the template field format, and the business rules, to process the information in populated template 240 in the appropriate fashion, and to output the desired policyholder cost information. For example, the test environment may calculate the predicted premium for a term having an effective date equal to the date in field 246.

As seen from FIGS. 3-5, at least some of the fields conforming to template 200 are populated with information specific to the policy for which an input file is being created. Specifically, in the example embodiment of FIGS. 3-5, the first template field (containing identifying information for the policy) and the third template field (containing a date calculated based upon a term date of the policy) are policy-specific. Because each copy of template 200 may require policy-specific information of this sort, the amount of time required to generate the input files may be greatly decreased by populating the template copies in an automated manner (e.g., rather than manually looking up the needed policy information, and populating fields based upon that information, for each policy).

### VI. EXEMPLARY METHOD FOR AGING AND TESTING INSURANCE POLICY DATA

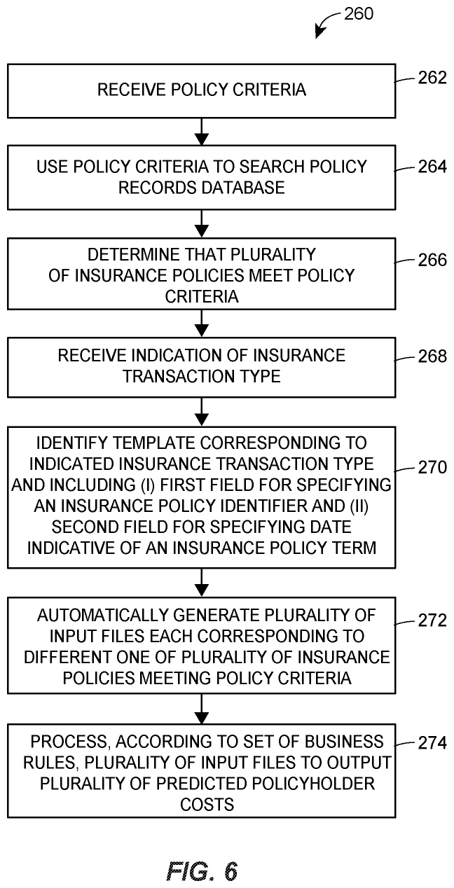

FIG. 6 depicts a flow diagram of an exemplary method 260 for testing business rules using a plurality of insurance policies, according to an embodiment. The plurality of insurance policies may be stored in a policy records database (e.g., policy records database 14 of FIG. 1), and may each be associated with information that uniquely identifies the insurance policy (e.g., a policy number), a date indicative of a past or current term of the insurance policy (e.g., an effective or expiration date of the current term), coverage information for the insurance policy (e.g., coverage types, deductibles, limits, etc.), and/or other policy information (e.g., policyholder information such as birth date, gender, claim history, etc.). In one embodiment, the method 260 may be implemented in (e.g., performed by one or more processors within) a computer or computer system, such as a computer included in, or a computer executing, test system 12 of FIG. 1, for example. The method 260 may be implemented by one or more processors executing instructions stored on a computer-readable medium (e.g., RAM, ROM, etc.) within test system 12, for example.

Initially, one or more policy criteria may be received (block 262). The policy criteria may be entered by a user and received by a policy extraction unit such as policy extraction unit 22 of FIG. 1, for example. The policy criteria may include any parameter(s) relating to insurance policies, such as geographic areas associated with the policies (e.g., state, geographic division, etc.) and/or types of coverage associated with the policies (e.g., comprehensive coverage, liability coverage, etc.). The policy criteria may also, or instead, include any parameter(s) relating to the policyholder (e.g., birth date, gender, number of household members, etc.).

The policy criteria received at block 262 may be used to search the policy records database in which at least the plurality of insurance policies are stored (block 264) and, in response, determine that the plurality of insurance policies meet the policy criteria (block 266). The search may be performed, and the determination may be made, by a policy extraction unit such as policy extraction unit 22 of FIG. 1, for example.

An indication of an insurance transaction type may be received (block 268). The indication may be received by a template population unit such as template population unit 24 of FIG. 1, for example. The indication may be a name of a transaction type (e.g., “COMPREHENSIVE”), a code associated with a transaction type (e.g., “COMP01” or “0001”), or a name or code of a template associated with the transaction type (e.g., “TEMP01” or “0001”), for example. The transaction type may be any transaction that can be performed with respect to an insurance policy, such as a policy renewal, a coverage change (e.g., add or remove a coverage type, change a deductible or limit, add an endorsement, etc.), a policy cancellation/termination, and/or a policy reinstatement, for example.

A template corresponding to the indicated insurance transaction type may be identified (block 270). The template may be identified by a template population unit such as template population unit 24 of FIG. 1, for example. In some embodiments, the identified template may include a first field for specifying an insurance policy identifier, and a second field for specifying a date indicative of an insurance policy term. The template may also include one or more other fields for specifying other policy information or policy modifications. In one embodiment and scenario where the indicated insurance transaction type is a coverage change, for example, the template may include a third field for specifying the coverage change that is to be modeled with respect to the policies meeting the search criteria.

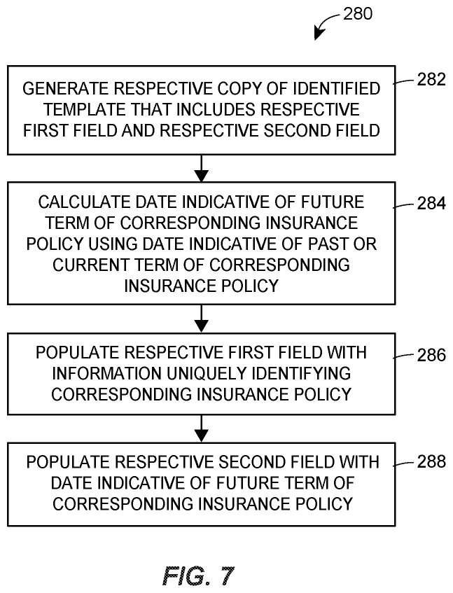

A plurality of input files may be automatically generated (block 272), with each input file corresponding to a different one of the plurality of insurance policies that were determined to meet the policy criteria at block 266. The input files may be automatically generated by a template population unit such as template population unit 24 of FIG. 1, for example. FIG. 7, discussed below, shows a method for performing block 272 with respect to each input file, according to one embodiment.

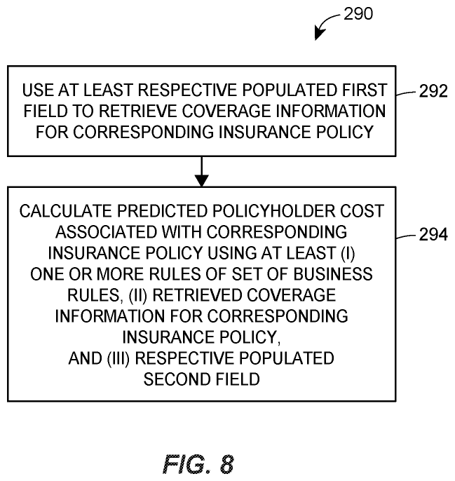

The plurality of input files automatically generated at block 272 may be processed according to a set of business rules to output a plurality of predicted policyholder costs (block 274). Each of the predicted policyholder costs may correspond to a different one of the plurality of input files being processed. The predicted policyholder costs may be insurance premiums for the insurance policies, discounts on the premiums, and/or premium surcharges, for example. The input files may be processed at block 272 by a test environment such as test environment 30 of FIG. 1, for example. In an embodiment, the processing of input files at block 272 may be automated batch processing, and may be similar to the “end-of-day” batch processing typically used by insurance companies. FIG. 8, discussed below, shows a method for performing block 274 with respect to each input file, according to one embodiment.

The business rules may reflect rules/logic that an insurance provider is considering for future implementation. The business rules may, for example, reflect one or more potential changes to insurance rating rules, one or more potential changes to insurance coverage pricing rules, one or more changes required based upon upcoming insurance industry regulations, etc. Alternatively, the business rules may reflect only existing rules/logic (e.g., if it is desired that current rules be tested to see how well those rules will handle current policies as those policies age).

In alternative embodiments, the method 260 may include more steps, fewer steps, and/or different steps than are shown in FIG. 6. For example, the method 260 may omit blocks 262, 264 and 266 (e.g., if all policies in a policy records database are to be tested, without extracting only those policies meeting certain criteria), and/or the method 260 may omit block 268 (e.g., if only a single template is available for use). As another example, the method 260 may include a block in which, for each of at least one of the insurance policies meeting the criteria, the respective predicted policyholder cost is caused to be displayed to a user via a user interface (e.g., by sending a command to display the cost data). As yet another example, the method 260 may include an additional block, performed after block 272 but before block 274, in which, for each generated input file, one or more fields of the template copy are modified (e.g., using one or more macros). For example, macros may be used to modify the date indicative of the future term in one field of the template copy, and/or, if present, information specifying a coverage change in another field of the template copy.

A. Exemplary Method for Generating Each Input File

FIG. 7 depicts a flow diagram of an exemplary method 280 for automatically generating an input file to be tested, according to an embodiment. In one embodiment, the method 280 may be implemented in (e.g., performed by one or more processors within) a computer or computer system, such as a computer included in, or a computer executing, test system 12 of FIG. 1, for example. The method 280 may be implemented by one or more processors executing instructions stored on a computer-readable medium (e.g., RAM, ROM, etc.) within test system 12, for example. As a more specific example, the method 280 may be performed by a template population unit such as template population unit 24 of FIG. 1, for example. The method 280 may be repeated once (or more than once) for each policy of interest, such that at least one input file is automatically generated for each extracted policy. For ease of explanation, the method 280 is described with reference to an embodiment in which, within block 272 in method 260 of FIG. 6, the method 280 may be repeated at least once for each of the insurance policies that were determined to meet the policy criteria at block 266.

In the method 280, a respective copy of the template identified at block 270 of method 260 may be generated (block 282). The respective copy of the template may include a respective first field corresponding to the first field of the template and a respective second field corresponding to the second field of the template. In embodiments where the template includes one or more additional fields (e.g., a third field for specifying a change in coverage), the respective copy may also include one or more respective fields corresponding to the additional field(s).

A date indicative of a future term of the insurance policy (i.e., the policy that corresponds to the input file being generated) may be calculated (block 284). The date may be calculated using a date indicative of a past or current term of the insurance policy. For example, the policy records database may be accessed to retrieve an effective (or expiration) date of a current term of the policy, and the date indicative of the future term may be an effective (or expiration) date that is calculated by adding one or more terms (e.g., sixth month intervals, one year intervals, etc.) to the retrieved date of the current term. In some embodiments, the method 260 of FIG. 6 may also include receiving an indication of a number of terms to age data (e.g., from a user via a user interface), and the date of the current term is advanced at block 284 by an amount corresponding to that number.

The respective first field may be populated with information that uniquely identifies the insurance policy corresponding to the input file being generated (block 286). For example, the respective first field may be populated with a policy number for the insurance policy. The policy number may be retrieved from the policy records database, for example. In some embodiments, the respective first field may also, or instead, be populated with other identifying information associated with the policy, such as state, division, etc.

The respective second field may be populated with the future term date calculated at block 284 (block 288). In embodiments where the template includes one or more additional fields (e.g., for specifying a coverage change, for specifying information identifying a policyholder such as name and/or address, etc.), the method 280 may also include one or more corresponding blocks in which the corresponding field(s) of the respective template copy is/are populated. In some embodiments and/or scenarios where the template includes a third field for specifying a coverage change, the coverage change inserted in the third field of the template copies may be the same for all extracted policies (e.g., for all iterations of the method 280). In other embodiments and/or scenarios, the coverage change may be dependent upon the policy for which the input file is being generated. For example, the coverage change specified in the third field of a template copy may be the addition of comprehensive coverage if the corresponding policy does not yet include such coverage, or no coverage change if the corresponding policy already includes such coverage. In some embodiments and/or scenarios where the template includes a third field for specifying information identifying a policyholder, the third field in the respective template copy may be automatically populated with anonymous policyholder information (e.g., “John Doe,” “000 Nowhere Drive,” etc.) to further ensure the privacy of policyholder information.

In some embodiments, blocks 286 and 288 (and/or other blocks, if any, in which fields of the template copy are populated) are performed in an integrated manner with block 282, e.g., such that the template copy includes the appropriately populated fields at the moment of creation. In other embodiments, the copy may be generated with blank (or default value) fields at block 282, and the fields are later populated at blocks 286 and 288.

B. Exemplary Method for Processing Each Input File According to Set of Business Rules to Output a Predicted Policyholder Cost

FIG. 8 depicts a flow diagram of an example method 290 for processing an input file according to a set of business rules to output a predicted policyholder cost, according to an embodiment. In one embodiment, the method 290 may be implemented in (e.g., performed by one or more processors within) a computer or computer system, such as a computer included in, or a computer executing, test system 12 of FIG. 1, for example. The method 290 may be implemented by one or more processors executing instructions stored on a computer-readable medium (e.g., RAM, ROM, etc.) within test system 12, for example. As a more specific example, the method 290 may be performed by a test environment such as test environment 30 of FIG. 1, for example. The method 290 may be repeated for each input file, such that at least one predicted policyholder cost is output for each input file. For ease of explanation, the method 290 is described with reference to an embodiment in which, within block 274 in method 260 of FIG. 6, the method 290 is repeated once for each of the input files that was generated at block 272.

In the method 290, the coverage information for the insurance policy that corresponds to the input file may be retrieved using at least the respective populated first field (block 292). In an embodiment where each insurance policy stored in the policy records database is also associated with policyholder information (e.g., birth date, gender, information about household members, etc.), the policyholder information for the insurance policy corresponding to the input file may also be retrieved using the respective populated first field.

The predicted policyholder cost associated with the insurance policy that corresponds to the input file may be calculated (block 294). In particular, the predicted policyholder cost may be calculated using at least one or more rules of the set of business rules, the coverage information retrieved at block 292, and/or the respective populated second field. In an embodiment in which the utilized template also includes a third field for specifying a change in coverage, and in which the respective template copy includes a corresponding third field populated with coverage change information, the cost calculation may also be based upon the populated third field. In an embodiment where the method 290 also includes using the respective populated first field to retrieve policyholder information for the insurance policy corresponding to the input file, the cost calculation may also be based upon the retrieved policyholder information.

A more specific example of the method 290, according to one embodiment, is provided with reference to the example populated template 240 of FIG. 5. In this example, the combination of state, division and policy number at field 242 may be processed at block 292 to retrieve the coverage types, limits and deductibles for the policy P00122, as well as policyholder information such as birth date and claim history. At block 292, the retrieved coverage information (as modified by the coverage change indicated in field 248) and policyholder information may be processed according to the business rules. As a part of this processing, the effective date in field 246 may be used for various purposes. For example, the effective date may be used, along with the policyholder's retrieved birth date, to determine what the policyholder's age will be on the effective date, and that age may be used to determine a premium adjustment. As another example, the effective date may be used, along with retrieved claim and/or accident history information for the policyholder, to determine whether a previous claim or accident is old enough (from the perspective of the effective date) to avoid a premium increase. As yet another example, the effective date may be used, along with a retrieved policy start date, to determine whether a “loyalty” premium discount should be applied.

### VII. EXEMPLARY COMPUTER SYSTEM FOR AGING, MODIFYING AND/OR TESTING POLICY RECORDS

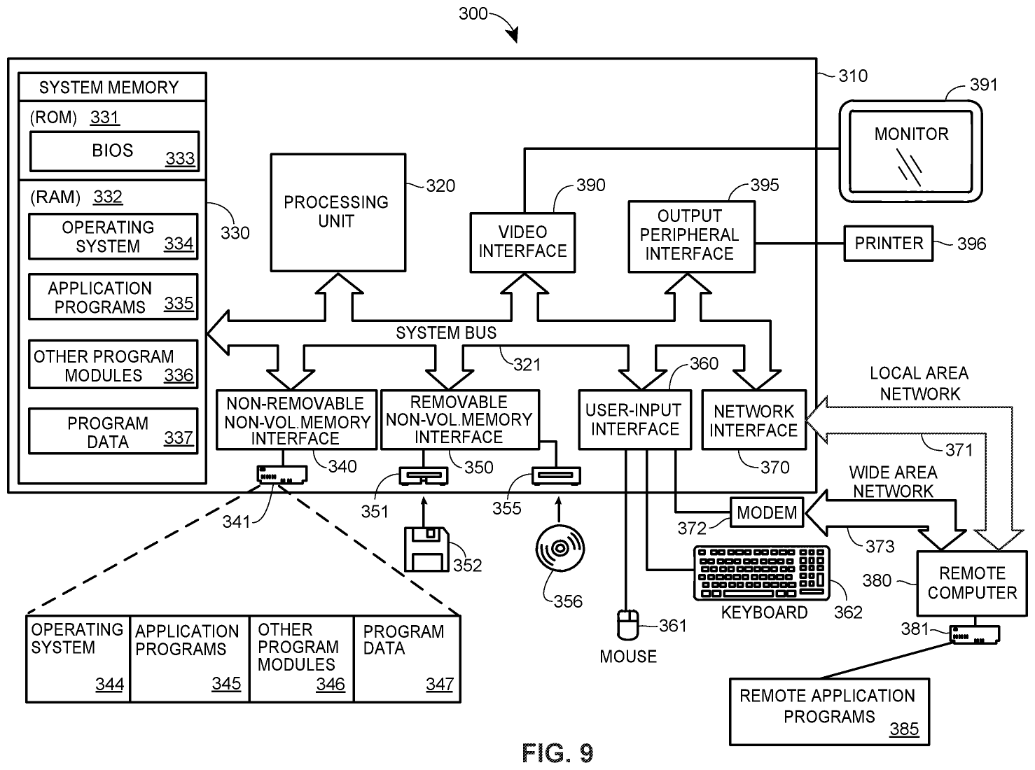

FIG. 9 depicts an exemplary computer system 300 in which the techniques for aging, modifying and/or testing policy data policies described herein may be implemented, according to an embodiment. The computer system 300 of FIG. 9 may include a computing device in the form of a computer 310. Components of the computer 310 may include, but are not limited to, a processing unit 320, a system memory 330, and/or a system bus 321 that couples various system components including the system memory 330 to the processing unit 320. The system bus 321 may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 310 typically may include a variety of computer-readable media. Computer-readable media can be any available media that can be accessed by computer 310 and includes both volatile and nonvolatile media, and both removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 310. Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above are also included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to, and/or presently being operated on, by processing unit 320. By way of example, and not limitation, FIG. 9 illustrates operating system 334, application programs 335, other program modules 336, and program data 337.

The computer 310 may also include other removable/non-removable, volatile/nonvolatile computer storage media. By way of example only, FIG. 9 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 may be connected to the system bus 321 through a non-removable memory interface such as interface 340, and magnetic disk drive 351 and optical disk drive 355 may be connected to the system bus 321 by a removable memory interface, such as interface 350.

The drives and their associated computer storage media discussed above and illustrated in FIG. 9 provide storage of computer-readable instructions, data structures, program modules and other data for the computer 310. In FIG. 9, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as cursor control device 361 (e.g., a mouse, trackball, touch pad, etc.) and keyboard 362. A monitor 391 or other type of display device is also connected to the system bus 321 via an interface, such as a video interface 390. In addition to the monitor, computers may also include other peripheral output devices such as printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 9. The logical connections depicted in FIG. 9 include a local area network (LAN) 371 and a wide area network (WAN) 373, but may also include other networks. Such networking environments are commonplace in hospitals, offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the input interface 360, or other appropriate mechanism. The communications connections 370, 372, which allow the device to communicate with other devices, are an example of communication media, as discussed above. In a networked environment, program modules depicted relative to the computer 310, or portions thereof, may be stored in the remote memory storage device 381. By way of example, and not limitation, FIG. 9 illustrates remote application programs 385 as residing on memory device 381.

The methods for aging, modifying and testing policy data described above may be implemented in part or in their entirety using one or more computer systems such as the computer system 300 illustrated in FIG. 9. The computer 310 and/or the remote computer 380 may be, be a part of, or execute the test system 12 of FIG. 1, for example. Application programs 335 and 336 may include software for executing the functionality of unit(s) 22, 24, 26 and/or 30 of FIG. 1, and/or for executing method 260 of FIG. 6, method 280 of FIG. 7, and/or method 290 of FIG. 8, for example. In embodiments where the test system 12 includes distributed processing, remote computer 380 may also execute some of the functionality of unit(s) 22, 24, 26 and/or 30 of FIG. 1, and/or execute portions of method 260 of FIG. 6, method 280 of FIG. 7, and/or method 290 of FIG. 8.

As another example, policy records database 14 and/or template database 16 of FIG. 1 may be stored in remote memory storage device 381, and extracted policies (or simply their identifiers), populated template copies, and/or test outputs may be stored in hard disk drive 341. As yet another example, a user may enter policy criteria, an indication of the insurance transaction type, test parameters, and/or other information (e.g., the number of terms to age policy data) via mouse 361 and/or keyboard 262, and may view outputs of the test environment 30 (e.g., predicted premiums) on monitor 391.

### VIII. EXEMPLARY METHOD

In one embodiment, a computer-implemented method of testing business rules using a plurality of insurance policies stored in a policy records database and each associated with at least (i) information uniquely identifying the insurance policy, (ii) a date indicative of a past or current term of the insurance policy, and (iii) coverage information for the insurance policy, may include receiving an indication of an insurance transaction type. The method may also include identifying, by one or more processors, a template corresponding to the indicated insurance transaction type and including (i) a first field for specifying an insurance policy identifier and/or (ii) a second field for specifying a date indicative of an insurance policy term. The method may also include automatically generating, by one or more processors, a plurality of input files each corresponding to a different one of the plurality of insurance policies. Automatically generating the plurality of input files may include, for each input file, generating a respective copy of the identified template that includes a respective first field corresponding to the first field of the identified template and a respective second field corresponding to the second field of the identified template, calculating a date indicative of a future term of the corresponding insurance policy using the date indicative of the past or current term of the corresponding insurance policy, populating the respective first field with the information uniquely identifying the corresponding insurance policy, and/or populating the respective second field with the date indicative of the future term of the corresponding insurance policy. The method may also include processing, by one or more processors and according to a set of business rules, the plurality of input files to output a plurality of predicted policyholder costs each corresponding to a different one of the plurality of input files. Processing the plurality of input files may include, for each input file, using at least the respective populated first field to retrieve the coverage information for the corresponding insurance policy, and/or calculating the predicted policyholder cost associated with the corresponding insurance policy using at least (i) one or more rules of the set of business rules, (ii) the retrieved coverage information for the corresponding insurance policy, and (iii) the respective populated second field. The method may include additional, fewer, or alternate actions, including those discussed elsewhere herein.

For instance, the method may further include, prior to automatically generating the plurality of input files, receiving one or more policy criteria, using the policy criteria to search the policy records database, and determining, by one or more processors, that the plurality of insurance policies meet the policy criteria. Receiving one or more policy criteria may include receiving one or both of (i) a geographic area associated with the plurality of insurance policies, and (ii) a type of coverage associated with the plurality of insurance policies.

Either (1) the date indicative of the past or current term of the insurance policy may be an effective date of the past or current term of the insurance policy, and calculating a date indicative of a future term of the corresponding insurance policy using the date indicative of the past or current term of the corresponding insurance policy may include calculating an effective date of the future term of the corresponding insurance policy using the effective date of the past or current term of the corresponding insurance policy, or (2) the date indicative of the past or current term of the insurance policy may be an expiration date of the past or current term of the insurance policy, and calculating a date indicative of a future term of the corresponding insurance policy using the date indicative of the past or current term of the corresponding insurance policy may include calculating an expiration date of the future term of the corresponding insurance policy using the expiration date of the past or current term of the corresponding insurance policy.

Receiving an indication of an insurance transaction type may include receiving an indication of at least one of (i) a policy renewal, (ii) a coverage change, (iii) a policy cancellation, or (iv) a policy reinstatement.

Receiving an indication of an insurance transaction type may include receiving an indication of a coverage change, identifying a template corresponding to the indicated transaction type may include identifying a template including (i) the first field, (ii) the second field, and (iii) a third field for specifying a change in coverage, automatically generating the plurality of input files may include, for each input file, generating a respective copy of the identified template that includes a respective first field corresponding to the first field of the identified template, a respective second field corresponding to the second field of the identified template, and a respective third field corresponding to the third field of the identified template, automatically generating the plurality of input files may further include, for each input file, populating the respective third field with information specifying the coverage change, and processing the plurality of input files according to the set of business rules may include, for each input file, calculating the predicted policyholder cost associated with the corresponding insurance policy using at least (i) one or more rules of the set of business rules, (ii) the retrieved coverage information for the corresponding insurance policy, (iii) the respective populated second field, and (iii) the respective populated third field.

The method may further include, prior to processing the plurality of input files according to the set of business rules, automatically modifying, by one or more processors executing one or more macros, and for each of the plurality of generated input files, one or both of (i) the date indicative of the future term of the corresponding insurance policy in the respective populated second field, and (ii) the information specifying the coverage change in the respective populated third field.

The method may further include receiving an indication of a number of terms to age data, calculating a date indicative of a future term of the corresponding insurance policy may include advancing the date indicative of the past or current term of the corresponding insurance policy by an amount corresponding to the number of terms to age data.

Processing the plurality of input files according to a set of business rules may include, for each input file, processing the plurality of input files according to one or both of (i) insurance rating rules, and (ii) insurance coverage pricing rules.

Each of the plurality of insurance policies stored in the policy records database may further be associated with policyholder information for the insurance policy, processing the plurality of input files according to the set of business rules may further include, for each input file, using at least the respective populated first field to retrieve the policyholder information for the corresponding insurance policy, and calculating the predicted policyholder cost associated with the corresponding insurance policy may include calculating the predicted policyholder cost associated with the corresponding insurance policy using at least (i) one or more rules of the set of business rules, (ii) the retrieved coverage information for the corresponding insurance policy, (iii) the retrieved policyholder information for the corresponding insurance policy, and (iv) the respective populated second field.

Identifying a template corresponding to the indicated transaction type may include identifying a template including (i) the first field, (ii) the second field, and (iii) a third field for specifying information identifying a policyholder, automatically generating the plurality of input files may include, for each input file, generating a respective copy of the identified template that includes a respective first field corresponding to the first field of the identified template, a respective second field corresponding to the second field of the identified template, and a respective third field corresponding to the third field of the identified template, and automatically generating the plurality of input files may further include, for each input file, populating the respective third field with anonymous policyholder information.

The method may further include, for each of one or more of the plurality of insurance policies, causing the respective predicted policyholder cost to be displayed to a user via a user interface.

### IX. EXEMPLARY COMPUTER-READABLE MEDIUM

In another embodiment, a non-transitory, computer-readable medium stores instructions that, when executed by one or more processors, may cause the one or more processors to receive an indication of an insurance transaction type, identify a template corresponding to the indicated insurance transaction type and including (i) a first field for specifying an insurance policy identifier and/or (ii) a second field for specifying a date indicative of an insurance policy term, and/or automatically generate a plurality of input files each corresponding to a different one of a plurality of insurance policies stored in a policy records database. Each of the plurality of insurance policies is associated with at least (i) information uniquely identifying the insurance policy, (ii) a date indicative of a past or current term of the insurance policy, and (iii) coverage information for the insurance policy. The instructions may cause the one or more processors to automatically generate the plurality of input files at least in part by, for each input file, generating a respective copy of the identified template that includes a respective first field corresponding to the first field of the identified template and/or a respective second field corresponding to the second field of the identified template, calculating a date indicative of a future term of the corresponding insurance policy using the date indicative of the past or current term of the corresponding insurance policy, populating the respective first field with the information uniquely identifying the corresponding insurance policy, and populating the respective second field with the date indicative of the future term of the corresponding insurance policy. The instructions may also cause the one or more processors to process, according to a set of business rules, the plurality of input files to output a plurality of predicted policyholder costs each corresponding to a different one of the plurality of input files, at least in part by, for each input file, using at least the respective populated first field to retrieve the coverage information for the corresponding insurance policy, and calculating a predicted policyholder cost associated with the corresponding insurance policy using at least (i) one or more rules of the set of business rules, (ii) the retrieved coverage information for the corresponding insurance policy, and (iii) the respective populated second field.

In some embodiments, the non-transitory, computer-readable medium may include one or more of the following features. Either (1) the date indicative of the past or current term of the insurance policy may be an effective date of the past or current term of the insurance policy, and calculating a date indicative of a future term of the corresponding insurance policy using the date indicative of the past or current term of the corresponding insurance policy may include calculating an effective date of the future term of the corresponding insurance policy using the effective date of the past or current term of the corresponding insurance policy, or (2) the date indicative of the past or current term of the insurance policy may be an expiration date of the past or current term of the insurance policy, and calculating a date indicative of a future term of the corresponding insurance policy using the date indicative of the past or current term of the corresponding insurance policy may include calculating an expiration date of the future term of the corresponding insurance policy using the expiration date of the past or current term of the corresponding insurance policy.

The insurance transaction type may include at least one of (i) a policy renewal, (ii) a coverage change, (iii) a policy cancellation, or (iv) a policy reinstatement.

The insurance transaction type may include a coverage change, the template corresponding to the indicated transaction type may include (i) the first field, (ii) the second field, and (iii) a third field for specifying a change in coverage, the respective copy of the identified template may include a respective first field corresponding to the first field of the identified template, a respective second field corresponding to the second field of the identified template, and a respective third field corresponding to the third field of the identified template, the instructions may cause the one or more processors to automatically generate the plurality of input files further by, for each input file, populating the respective third field with information specifying the coverage change, and the instructions may cause the one or more processors to, for each input file, calculate the predicted policyholder cost associated with the corresponding insurance policy using at least (i) one or more rules of the set of business rules, (ii) the retrieved coverage information for the corresponding insurance policy, (iii) the respective populated second field, and (iv) the respective populated third field.

The instructions, when executed by the one or more processors, may further cause the one or more processors to receive an indication of a number of terms to age data, and the instructions may cause the one or more processors to automatically generate the plurality of input files in part by, for each input file, calculating the date indicative of the future term of the corresponding insurance policy at least by advancing the date indicative of the past or current term of the corresponding insurance policy by an amount corresponding to the number of terms to age data.

The set of business rules may include one or both of (i) insurance rating rules, and (ii) insurance coverage pricing rules.

Each of the plurality of insurance policies stored in the policy records database may be further associated with policyholder information for the insurance policy, the instructions may cause the one or more processors to process the plurality of input files according to the set of business rules further by, for each input file, using at least the respective populated first field to retrieve the policyholder information for the corresponding insurance policy, and the instructions may cause the one or more processors to calculate the predicted policyholder cost associated with the corresponding insurance policy using at least (i) the one or more rules of the set of business rules, (ii) the retrieved coverage information for the corresponding insurance policy, (iii) the retrieved policyholder information for the corresponding insurance policy, and (iv) the respective populated second field.

The instructions, when executed by the one or more processors, may further cause the one or more processors to, for each of one or more of the plurality of insurance policies, cause the respective predicted policyholder cost to be displayed to a user via a user interface.

### X. ADDITIONAL CONSIDERATIONS

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for aging and/or modifying policy data for test purposes through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer system for testing business rules for applying a transaction to insurance policies stored in a policy records database, the computer system configured to:
receive, via a user interface, one or more user-entered policy criteria;
identify, via a policy extraction unit, a plurality of insurance policies in the policy records database that meet the user-entered policy criteria;
receive, via the user interface, a user-entered indication of an insurance transaction type;
identify, via a template population unit, a transaction template corresponding to the indicated insurance transaction type and including a field for specifying a date indicative of an insurance policy term;
receive, via the user interface, a user-entered future date representative of the insurance policy term;
create, via a template population unit, a plurality of input files based on the transaction template for respective ones of the plurality of insurance policies, each of the input files populated with policy specific data from the respective insurance policy and the future date;
generate, via one or more processors, a plurality of predicted policyholder costs for respective ones of the plurality of policies, at least by modeling a test transaction of the insurance transaction type for the future date for each of the plurality of policies, wherein modeling the test transaction includes applying one or more business rules to the respective input file; and
provide, via the user interface, the plurality of predicted policyholder costs, wherein the plurality of predicted policyholder costs can be used to modify and/or verify the one or more business rules to implement an actual insurance transaction of the insurance transaction type.

2. The computer system of claim 1, wherein the transaction template further includes a second field for specifying coverage.

3. (canceled)

4. (canceled)

5. The computer system of claim 1, wherein the one or more user-entered policy criteria include a geographic area associated with the plurality of insurance policies.

6. The computer system of claim 1, wherein the one or more user-entered policy criteria include a type of coverage associated with the plurality of insurance policies.

7. The computer system of claim 1, wherein the indication of the insurance transaction type includes a policy renewal.

8. The computer system of claim 1, wherein the indication of the insurance transaction type includes a coverage change.

9. The computer system of claim 1, wherein the indication of the insurance transaction type includes a discount change.

10. A computer-implemented method of testing business rules for applying a transaction to insurance policies stored in a policy records database, the method comprising:
receiving, via one or more processors, one or more user-entered policy criteria;
using the user-entered policy criteria to search, via the one or more processors, the policy records database;
identifying, via the one or more processors, a plurality of insurance policies in the policy records database that meet the user-entered policy criteria;
receiving, via the one or more processors, a user-entered indication of an insurance transaction type;
identifying, via the one or more processors, a transaction template corresponding to the indicated insurance transaction type and including a field for specifying a date indicative of an insurance policy term;
creating, via the one or more processors, a plurality input files based on the transaction template for respective ones of the plurality of insurance policies, each of the input files populated with policy specific data from the respective insurance policy and the future date;
generating, via one or more processors, a plurality of predicted policyholder costs for respective ones of the plurality of policies, at least by modeling a test transaction of the insurance transaction type for the future date for each of the plurality of policies, wherein modeling the test transaction includes applying one or more business rules to the respective input file; and
providing, the one or more processors at a user interface, the plurality of predicted policyholder costs, wherein the plurality of predicted policyholder costs can be used to modify and/or verify the one or more business rules to implement an actual insurance transaction of the insurance transaction type.

11. The computer-implemented method of claim 10, wherein the transaction template further includes a second field for specifying coverage.

12. (canceled)

13. (canceled)

14. The computer-implemented method of claim 10, wherein the one or more user-entered policy criteria includes a geographic area associated with the plurality of insurance policies.

15. The computer-implemented method of claim 10, wherein the one or more user-entered policy criteria includes a type of coverage associated with the plurality of insurance policies.

16. The computer-implemented method of claim 10, wherein the indication of the insurance transaction type includes a policy renewal.

17. The computer-implemented method of claim 10, wherein the indication of the insurance transaction type includes a coverage change.

18. A computer-implemented method of simulating a financial performance of a modification to an insurance policy, the method comprising:
modifying a premium, rate, discount, rebate, reward, coverage, coverage amount, deductible, or other condition associated with an insurance policy that impacts a financial performance of the insurance policy;
creating a virtual template that holds insurance policy data elements, the insurance policy data elements including a policy number, a policy expiration date, and an insurance premium, rate, discount, rebate, reward, coverage, coverage amount, or deductible;
using the virtual template to adjust one or more of the insurance policy data elements to a specific value to trigger one or more insurance-related event or otherwise to age the insurance policy;
determining a financial impact of the insurance-related event on the financial performance of the insurance policy; and
verifying that the financial impact of the insurance-related event on the financial performance of the insurance policy was as expected such that an accuracy of the modification to the insurance policy is tested before being implemented.

19. The computer-implemented method of claim 18, wherein the one or more insurance-related event includes an insurance policy renewal; and
the insurance policy is an auto, home owners, renters, life, or health insurance policy.

20. The computer-implemented method of claim 18, wherein the one or more insurance-related event includes an insurance policy change or endorsement; and
the insurance policy is an auto, home owners, renters, life, or health insurance policy.
